(19) United States
(12) Patent Application Publication
(10) Pub. No.: US 2025/0196965 A1
(43) Pub. Date: Jun. 19, 2025

(54) BICYCLE HANDLEBAR WITH OVAL CROSS SECTION AND ADAPTER PIECE

(71) Applicant: Sport Import GmbH, Edewecht (DE)

(72) Inventor: Swen LAUER, Garmisch-Partenkirchen (DE)

(73) Assignee: Sport Import GmbH, Edewecht (DE)

(21) Appl. No.: 19/067,273

(22) Filed: Feb. 28, 2025

Related U.S. Application Data
(63) Continuation of application No. PCT/EP2023/073549, filed on Aug. 28, 2023.

(30) Foreign Application Priority Data
Aug. 29, 2022 (DE) 102022208896.4

(51) Int. Cl. B62K 21/16

(52) U.S. Cl. CPC B62K 21/16

(57) ABSTRACT

The concept described herein relates to a bicycle handlebar having a centrally arranged clamping section for clamping the bicycle handlebar in a stem, wherein the clamping section has an at least sectionally oval cross section, and having an adapter piece arranged on the outside on the clamping section, wherein the adapter piece has a geometric shaping which complements the oval cross section such that the clamping section and the adapter piece together form a circular cross section. According to the invention, the clamping section without the adapter piece has an oval outer contour, whereas the clamping section with the applied adapter piece has a circular outer contour.

### CROSS-REFERENCE TO RELATED APPLICATIONS

This application is a continuation of copending International application No. PCT/EP2023/073549, filed Aug. 28, 2023, which is incorporated herein by reference in its entirety, and additionally claims priority from German Application No. 102022208896.4, filed Aug. 29, 2022, which is also incorporated herein by reference in its entirety.

### TECHNICAL FIELD

The innovative concept described herein relates to a bicycle handlebar. It has an oval cross section in order to allow better flex behavior. In order to nevertheless be able to install the oval handlebar in a standard stem, an adapter piece is provided according to the invention, which serves to give the handlebar a circular outer contour in the region of the stem clamping.

### BACKGROUND OF THE INVENTION

A bicycle handlebar is mounted on a bicycle by the handlebar being clamped firmly in a stem. For this purpose, the stem is usually of two-part design. A front plate (in the direction of travel) is removable so that the handlebar can be inserted into the stem. The plate is then placed again on the stem and screwed on. Thus, a clamping force is exerted on the handlebar, which holds the handlebar firmly in the stem in a rotation-proof manner.

The so-called clamping width indicates the radius of the handlebar at its clamping section, by means of which the handlebar is clamped firmly in the stem. At the same time, the clamping width also describes the radius of the complementary clamping surface of the stem, into which the handlebar is inserted. In order to ensure compatibility of handlebars and stems of different manufacturers, a few different standards or dimensions have become established. Clamping widths of 25.4 mm, 31.8 mm or 35 mm, for example, are quite common nowadays.

In order to further ensure compatibility, handlebars and stems are to have complementary geometric shapes at their respective clamping sections or clamping surfaces. Therefore, currently available handlebars have a circular cross section, and the receiving section of the stems is also formed to be substantially circular.

As is known, a tube with a circular cross section has a relatively high rigidity. On the one hand, this is desirable in order to design the handlebar to be as stable as possible. On the other hand, however, this has the result that the handlebar is very rigid or inflexible, as a result of which vibrations and shocks, which may occur while riding, are transmitted to the driver in a largely unfiltered manner. This may quickly lead to fatigue.

One approach is making the handlebar flexible by special material mixtures or shaping. However, whenever the shape of the handlebar deviates from the standardized circular outer contour, compatibility with standardized stems is no longer provided. Specifically matching stems then have to be developed, which is associated with higher development and manufacturing costs. In addition, acceptance in the market is only extremely low since end customers are only rarely prepared to purchase a new stem, even though only the handlebar is to be exchanged. In addition, many cyclists would like to continue using their previous stem.

It would therefore be desirable to provide a flexible handlebar which is compatible with conventional standards.

### SUMMARY

According to an embodiment, a bicycle handlebar may have: a centrally arranged clamping section for clamping the bicycle handlebar in a stem, wherein the clamping section has an at least sectionally oval cross section, and an adapter piece arranged on the outside on the clamping section, wherein the adapter piece has a geometric shaping which complements the oval cross section such that the clamping section and the adapter piece together form a circular cross section, wherein the clamping section without the adapter piece has an oval outer contour, and wherein the clamping section with the applied adapter piece has a circular outer contour.

According to another embodiment, a steering unit for a bicycle may have: a bicycle handlebar according to any of the preceding claims, and a stem in which the clamping section of the bicycle handlebar can be clamped together with the adapter piece, wherein the stem has a clamping width which corresponds to the radius of the circular outer contour which the clamping section forms together with the adapter piece.

The bicycle handlebar according to the invention has a centrally arranged clamping section, by means of which the bicycle handlebar can be clamped firmly in a stem. The clamping section has an at least sectionally oval cross section, i.e. the handlebar has an oval outer contour in the region of the clamping section. According to the invention, an adapter piece is provided, which is arranged on the outside on the clamping section of the handlebar. According to the invention, the adapter piece has a geometric shaping which complements the oval cross section of the handlebar such that the clamping section and the adapter piece together form a circular cross section. As a result, the handlebar is given a circular outer contour in the region of the clamping section so that the handlebar, despite its oval cross section, is still compatible with the current standards and can be used with standard stems.

According to the invention, a steering unit for a bicycle is also proposed, wherein the steering unit has a bicycle handlebar according to the invention described herein and a stem, wherein the clamping section of the bicycle handlebar together with the adapter piece can be clamped in the stem. The stem has a clamping width which corresponds to the radius of the circular outer contour which the clamping section forms together with the adapter piece.

The stem has a clamping surface which cooperates in a force-fitting manner with the clamping section of the bicycle handlebar in order to clamp the bicycle handlebar in the stem. According to a further aspect of the invention, it is proposed that the stem has a toothing in the region of the clamping surface and that the adapter piece has a complementary mating toothing. The mating toothing on the adapter piece is configured to engage in the toothing of the stem so that the bicycle handlebar is secured against rotation.

Embodiments of the steering unit provide for a stepwise rotation of the handlebar in the stem to be possible in a rotation angle range between ±1° and ±10° by means of the toothing.

### BRIEF DESCRIPTION OF THE DRAWINGS

Some embodiments are illustrated exemplarily in the drawing and will be explained below, in which:

FIG. 1A shows a front perspective view of a handlebar with an adapter piece according to an embodiment;

FIG. 1B shows a rear perspective view of the handlebar with the adapter piece according to an embodiment;

FIG. 2 shows an enlarged illustration of a perspective view of a handlebar with an adapter piece according to an embodiment; and

FIG. 3 shows a schematic sectional illustration of a handlebar with an adapter piece according to an embodiment.

### DETAILED DESCRIPTION OF THE INVENTION

Embodiments are described below in more detail with reference to the figures, wherein elements with the same or similar function are provided with the same reference numerals.

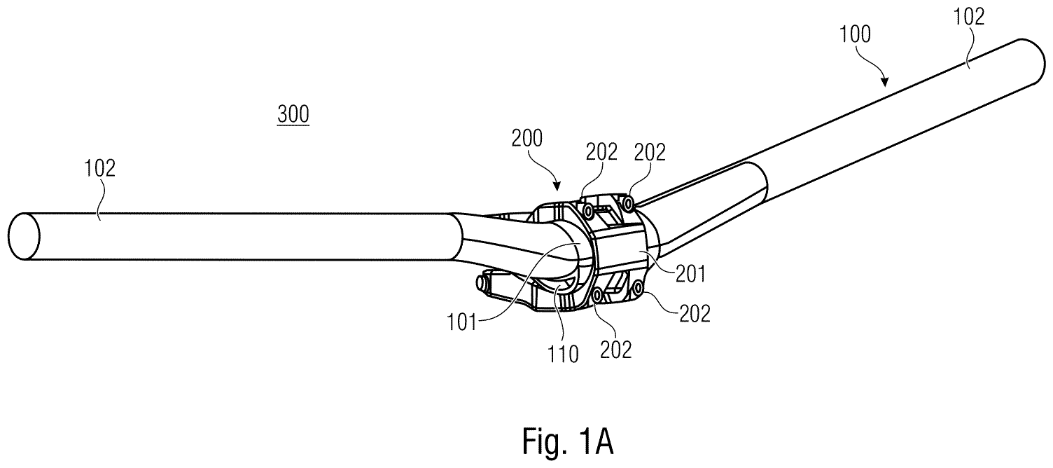

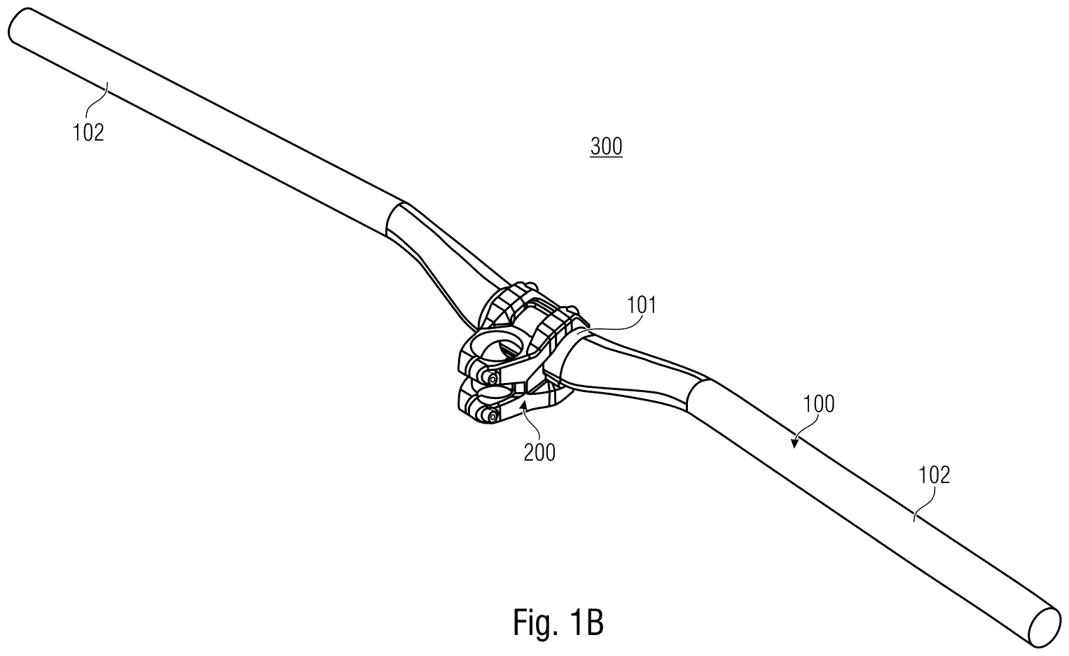

FIGS. 1A and 1B each show perspective views of a bicycle handlebar 100 according to the invention, which is clamped firmly in a standard stem 200. The handlebar 100 has a grip section 102 at each of the two ends. Between the grip sections 102, the handlebar 100 has a centrally arranged clamping section 101.

The clamping section 101 is clamped in the stem 200. A front plate 201 of the stem 200 can be removed for this purpose. The handlebar 100 is then inserted into the open stem 200 at its clamping section 101. The front plate 201 is then put back in place again so that the clamping section 101 is enclosed, and the plate 201 is tightened by means of screws 202. As a result, the clamping surfaces of the stem 200 exert a clamping force on the handlebar 100 or on the clamping section 101 so that the handlebar 100 is fixed in the stem 200 in a force-fitting and rotation-proof manner.

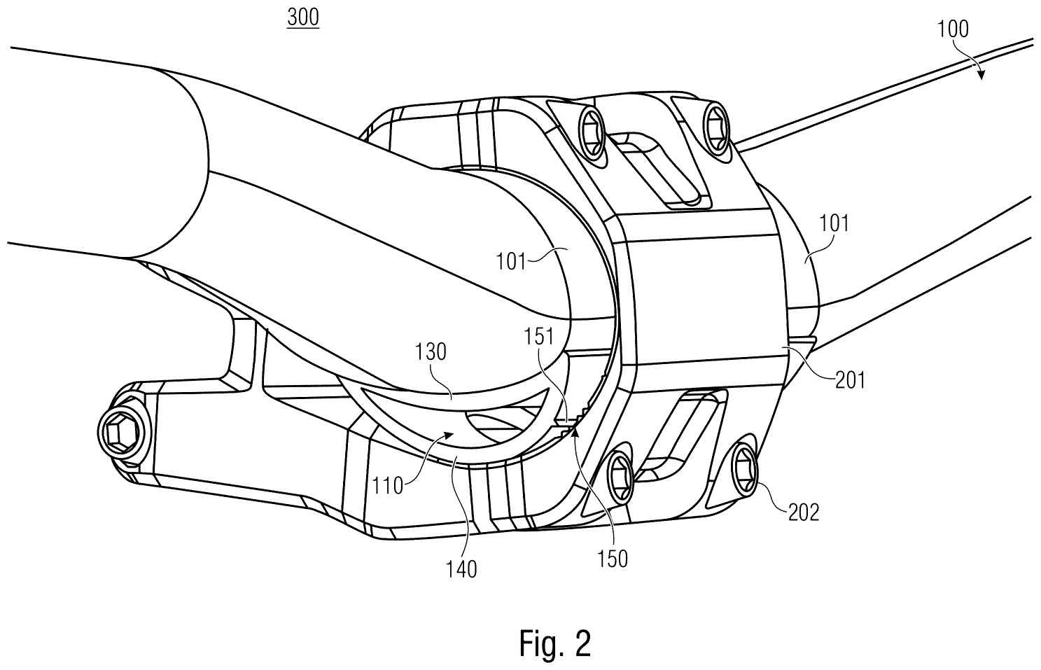

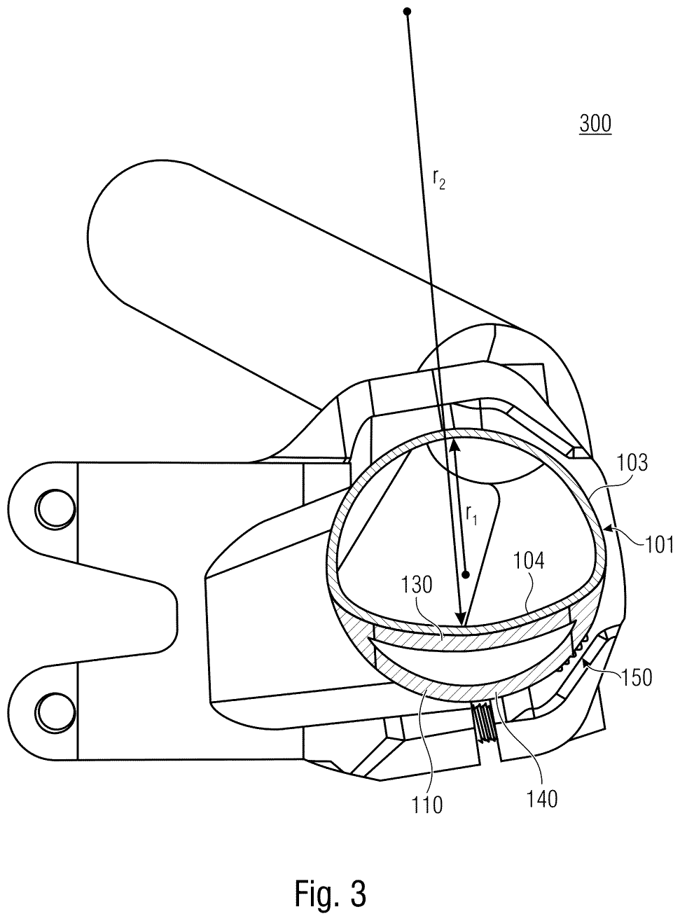

As can be seen in FIG. 2, the bicycle handlebar 100 according to the invention has an adapter piece 110. The adapter piece 110 is clamped between the handlebar 100 and the stem 200. The function of the adapter piece 110 will be explained in more detail referring to FIG. 3.

FIG. 3 shows a cross-sectional illustration of the handlebar 100, the stem 200 and the adapter piece 110. As can be seen here, the handlebar 100 has an oval cross section in the region of the clamping section 101. For example, the clamping section 101 may have a circular partial section 103 with a first radius r₁ in a first region. In an opposite second region, the clamping section 101 may have a flattened partial section 104 with a significantly larger second radius r₂ in comparison to the circular partial section 103.

In the exemplary embodiment illustrated in FIG. 3, the clamping section 101 has the circular partial section 103 at the top (i.e. facing away from a contact surface of the bicycle), whereas the clamping section 101 has the flattened partial section 104 in the opposite lower part (i.e. facing a contact surface of the bicycle). However, a vice versa situation would also be conceivable.

In addition, one half of the clamping section 101 may be divided into the first region with the circular partial section 103 and a further half into the second region with the flattened partial section 104. This means that one half of the clamping section 101 could be formed to be circular, whereas the other half of the clamping section 101 could be formed to be flattened. This would accordingly result in the oval outer contour of the clamping section 101 illustrated here. Other geometric subdivisions are also conceivable.

The oval outer contour or the oval cross section of the clamping section 101 has the advantage that the handlebar 100 becomes more flexible as a result. In the region of the clamping or clamping on the stem 200, the oval handlebar 100 according to the invention has a significantly larger flex in comparison to conventional handlebars which have a circular cross section in the region of the clamping section. This is best comparable to a leaf spring. Due to the oval shape of the clamping section 101, the handlebar 100 is given a higher flexibility, which manifests itself by a more pronounced oscillation behavior perpendicular to the surface of the flattened section 104. In the embodiment shown here, the handlebar 100 would therefore be able to vibrate significantly more upward and downward (in relation to the contact surface of the bicycle) than forward or rearward. The flexibility of the handlebar 100 can be changed or adjusted by rotating the handlebar 100 within the stem 200. The orientation of the flattened partial section 104 also changes by the rotation of the handlebar 100. A maximum flex can be achieved, for example, by the flattened partial section 104 being oriented substantially parallel to the contact surface of the bicycle.

The desired flex behavior of the handlebar 100 can be determined by means of suitable methods, for example by means of the finite element method (FEM), in order to set up corresponding oval cross sections.

The grip sections 102 mentioned above referring to FIGS. 1A and 1B can have a circular cross section or a circular outer contour. This in turn allows the handlebar 100 to have less flexibility in the region of the grip sections 102 in comparison to the oval clamping section 101.

As mentioned above and as can be seen best in FIGS. 2 and 3, the handlebar 100 according to the invention can have at least a circular partial section 103. The radius r1 of the circular partial section 103 may substantially correspond to the radius of the clamping surfaces of the stem 200 so that the circular partial section 103 can be inserted into the stem 200 in a precisely fitting manner. The circular partial section 103 is therefore compatible with the circular clamping surfaces of a standardized stem 200. However, the flattened section 104 just mentioned deviates from the ideal circular shape. In this region, the handlebar 100 according to the invention is thus initially not compatible with the circular clamping surfaces of standardized stems 200.

In order to take account of this circumstance, the adapter piece 110 already mentioned briefly above is provided according to the invention. The adapter piece 110 is arranged on the outside on the clamping section 101. According to the invention, the adapter piece 110 has a geometric shaping which complements the oval cross section of the clamping section 101 such that the clamping section 101 and the adapter piece 110 together form a circular cross section.

The clamping section 101 of the handlebar 100 thus initially has an oval outer contour without the adapter piece 110. However, when the adapter piece 110 is applied to the clamping section 101, the clamping section 101 and the applied adapter piece 110 together have a circular outer contour. As a result, the clamping section 101 which is given a circular outer contour by means of the mounted adapter piece 110 can be clamped in the circular clamping surfaces of standardized stems 200. The handlebar 100 according to the invention thus becomes compatible with standardized stems.

As can be seen in FIGS. 2 and 3, the adapter piece 110 can have a concave indentation 130 on a side facing the clamping section 101. The concave indentation 130 may have a radius which substantially corresponds to the larger, second radius r₂ of the flattened partial section 104. In other words, the concave indentation 130 may have an outer contour which is complementary to the outer contour of the flattened, second partial section 104. Thus, the adapter piece 110 can be arranged on the second partial section 104 of the clamping section 101 in a precisely fitting manner.

Expressed somewhat more generally, the adapter piece 110 may have a surface on a side facing the clamping section 101, which is complementary to a surface of the clamping section 101 at this very point.

The adapter piece 110 may have a convex bulge 140 on a side facing away from the clamping section 101. The convex bulge 140 may have a radius which substantially corresponds to the first radius r₁ of the circular partial section 103 so that the convex bulge 140 of the adapter piece 110 together with the circular, first partial section 103 of the clamping section 101 forms the circular outer contour.

The handlebar 100 and the adapter piece 110 can thus be clamped together in the stem 200 or between the clamping surfaces of the stem 200 in order to fix the handlebar 100 in the stem 200. Since the mounted adapter piece 110 gives the clamping section 101 of the handlebar 100 a circular outer contour, the handlebar 100 can be clamped firmly in the circular clamping surfaces of standardized stems. The handlebar 100 according to the invention thus becomes standard-compatible by means of the adapter piece 110 according to the invention, i.e. the oval handlebar 100 according to the invention can be used with standard-conforming stems.

However, it is also conceivable for the handlebar 100 to be combined with a special stem 200. A further aspect of the present invention accordingly relates to a steering unit 300 which has the oval handlebar 100 described herein together with the adapter piece 110 and a stem 200 described in more detail below.

Referring again to FIGS. 2 and 3, the stem 200 may have a toothing 150, for example, in the region of the clamping surfaces which cooperate in a force-fitting manner with the clamping section 101 of the handlebar 100. The toothing 150 in the stem 200 may, as illustrated exemplarily, have a row of teeth with several teeth and several tooth gaps arranged therebetween.

The adapter piece 110 may have a complementary mating toothing 151. The mating toothing 151 may, for example, include a single tooth, as is shown purely exemplarily in FIG. 2. The mating toothing 151 provided on the adapter piece 110 is configured to engage in the toothing 150 of the stem 200 so that the bicycle handlebar 100 is secured against rotation in a form-fitting manner. For example, the single tooth of the mating toothing 151 of the adapter piece 110 may engage in one of the tooth gaps of the toothing 150 of the stem 200.

Alternatively, it would be conceivable for the toothing 150 on the stem 200 to have only a single tooth and for the mating toothing 151 on the adapter piece 110 to correspondingly have a row of teeth with several teeth and several tooth gaps arranged therebetween.

Irrespective of the specific configuration, the toothing 150 and the mating toothing 151 always form a tooth arrangement.

According to an embodiment, the toothing 150 on the stem 200 and the mating toothing 151 on the adapter piece 110 may be configured such that the handlebar 100 can be rotated in steps, i.e. tooth by tooth, by means of the tooth arrangement 150, 151. Advantageously, the handlebar 100 can be rotated in steps in a rotation angle range between ±1° and ±10°. In a further embodiment, the handlebar 100 can be rotated in steps in a rotation angle range between ±1° and ±6°. This means that the handlebar 100 can be rotated upwards or downwards in these regions. Optionally, a scale may be provided on the handlebar 100 and/or on the stem 200 and/or on the adapter piece 110, which allows the corresponding angle to be read.

The adjustability of bicycle handlebars 100 in general is desirable, but often cannot be carried out without problems. Many handlebars have a so-called back sweep, i.e. a rearward curvature (in relation to the direction of travel of the bicycle), and/or an up sweep, i.e. an upward curvature. In addition, there is the so-called rise, i.e. the elevation of the grip sections 102 in relation to the clamping section 101. All these factors may be different from handlebar to handlebar. The handlebar can be adjusted in dependence on these factors. However, this can only take place by rotating the handlebar 100 in the stem 200. This means that a rotation of the handlebar 100 changes the back sweep (if present) and the up sweep (if present) equally. Depending on the handlebar model, a rotation by only a few degrees can already make up a considerable difference. The adjustment of the handlebar 100 here takes place according to manufacturer specifications or according to personal preferences.

For the end customer, it is difficult to find the exact zero position as the starting position from which the handlebar 100 is to be rotated by the desired number of degrees. Scales printed on the handlebar 100 are often not compatible with scales printed on stems 200 of other manufacturers. In addition, with stepless adjustability, due to the purely force-fitting clamping of conventional stems, it cannot be guaranteed that the end customer adjusts exactly the desired number of degrees, in particular if the rotation is to take place with a precision of 1° degree.

The steering unit 300 according to the invention, on the other hand, allows precise rotation of the handlebar 100 within the stem 200 by means of the tooth arrangement 150, 151 mentioned above. According to an embodiment, the toothing 150 and the mating toothing 151 may be configured to allow a 1° rotation of the handlebar 100 in the stem 200 per tooth, i.e. the handlebar 100 is rotated by exactly 1° per tooth. Thus, the end customer can very easily determine by how many degrees the handlebar 100 is rotated.

In addition, a certain tooth gap in the row of teeth of the tooth arrangement 150, 151 may define a zero position. With reference to FIG. 2, for example, the lowermost tooth gap or the uppermost tooth gap could define the zero position. It would also be conceivable for the middle tooth gap to define the zero position. In this case, the handlebar 100 could be rotated to the same extent in steps in a positive and in a negative direction of rotation, i.e. the handlebar 100 could be rotated both forward in steps and back in steps in the tooth arrangement 150, 151.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A bicycle handlebar comprising:
a centrally arranged clamping section for clamping the bicycle handlebar in a stem,
wherein the clamping section comprises an at least sectionally oval cross section, and an adapter piece arranged on the outside on the clamping section, wherein the
adapter piece comprises a geometric shaping which complements the oval cross section such that the clamping section and the adapter piece together form a circular cross section,
wherein the clamping section without the adapter piece comprises an oval outer contour, and wherein the clamping section with the applied adapter piece comprises a circular outer contour.

2. The bicycle handlebar according to claim 1,
wherein the clamping section comprises a circular partial section with a first radius r₁ in a first region, and
wherein the clamping section comprises a flattened partial section with a significantly larger second radius r₂ in an opposite second region in comparison to the circular partial section.

3. The bicycle handlebar according to claim 2,
wherein one half of the clamping section is divided into the first region with the circular partial section and a further half is divided into the second region with the flattened partial section.

4. The bicycle handlebar according to claim 2,
wherein the flattened partial section of the clamping section is oriented substantially parallel to the contact surface of the bicycle when the bicycle handlebar is mounted.

5. The bicycle handlebar according to claim 2,
wherein the first radius r₁ of the circular partial section corresponds to the radius of the stem.

6. The bicycle handlebar according to claim 2,
wherein the adapter piece comprises a concave indentation on a side facing the clamping section, wherein this concave indentation comprises a radius which corresponds to the larger, second radius r₂ of the flattened partial section so that the adapter piece can be arranged on the second partial section of the clamping section in a precisely fitting manner.

7. The bicycle handlebar according to claim 2,
wherein the adapter piece comprises a convex bulge on a side facing away from the clamping section, wherein this convex bulge comprises a radius which corresponds to the first radius r₁ of the circular partial section so that the convex bulge of the adapter piece together with the circular, first partial section of the clamping section forms the circular outer contour.

8. The bicycle handlebar according to claim 2,
wherein the bicycle handlebar comprises grip sections which each extend laterally away from the clamping section, and wherein these grip sections comprise a circular cross section.

9. A steering unit for a bicycle, comprising:
a bicycle handlebar according to any of the preceding claims, and
a stem in which the clamping section of the bicycle handlebar can be clamped together with the adapter piece,
wherein the stem comprises a clamping width which corresponds to the radius of the circular outer contour which the clamping section forms together with the adapter piece.

10. The steering unit according to claim 9,
wherein the stem comprises a clamping surface which cooperates in a force-fitting manner with the clamping section of the bicycle handlebar in order to clamp the bicycle handlebar in the stem,
wherein the stem comprises a toothing in the region of the clamping surface, and
wherein the adapter piece comprises a complementary mating toothing configured to engage in the toothing of the stem so that the bicycle handlebar is secured against rotation in a form-fitting manner.

11. The steering unit according to claim 10,
wherein the toothing and the mating toothing are configured to allow a step-by-step rotation of the handlebar in the stem in a rotation angle range between ±1° and ±10°.

12. The steering unit according to claim 10,
wherein the toothing and the mating toothing are configured to allow a 1° rotation of the handlebar in the stem per tooth.
